(19) United States
(12) Patent Application Publication
(10) Pub. No.: US 2002/0198965 A1
(43) Pub. Date: Dec. 26, 2002

(54) Method and apparatus to facilitate establishing a distributed internet application platform

(76) Inventor: Matthew J. Kraft, Seattle, WA (US)

Correspondence Address: PARK, VAUGHAN & FLEMING LLP, 508 SECOND STREET, SUITE 201, DAVIS, CA, 95616, US

(21) Appl. No.: 09/892,716

(22) Filed: Jun. 26, 2001

(51) Int. Cl. G06F 15/16

(52) U.S. Cl. 709/219; 709/218

(57) ABSTRACT

One embodiment of the present invention provides a system to facilitate remote access by a user to a virtual desktop on a server through a web browser. The system operates by downloading a terminal services control to the web browser. Next, the user receives a logon window from the server. After logging on to the server through the logon window the user access the virtual desktop on the server through the web browser.

### BACKGROUND

1. Field of the Invention

The present invention relates to a computing platform. More specifically, the present invention relates to a method and an apparatus to facilitate establishing a distributed Internet application platform.

2. Related Art

Computer system administrators and users wanting to share resources commonly use client computing systems to access a server for the shared data and programs. In many cases, the server may be one virtual server out of many virtual servers hosted on a server computing device.

Typically, accessing a virtual server involves using application service provider (ASP) based web applications to interact with the server. These ASP-based web applications have several drawbacks, which present problems for administrators, users, and support personnel. For example, many ASP-based web applications have inadequate security—potentially allowing access from other virtual servers on the same server computing device, allowing access to other virtual servers on the same server computing device, and allowing unauthorized access to the virtual server from outside the virtual server.

These same ASP-based web applications can present varied and confusing interfaces to users, with each one requiring users to learn different procedures. This confusion often leads users to contact technical support personnel in order to resolve misunderstandings of how the interfaces operate.

ASP-based web applications can lack flexibility; overwhelming an entry-level user, and, at the same time, inadequately supporting system administrators and technical support personnel.

Additionally, ASP-based web applications typically support a single platform for accessing the virtual server. Porting these ASP-based web applications to a different platform can require extensive resources and can result in differing interfaces for common functionality.

What is needed is a method and an apparatus that facilitates establishing a distributed internet application platform, while eliminating the problems cited above.

### SUMMARY

One embodiment of the present invention provides a system to facilitate remote access by a user to a virtual desktop on a server through a web browser. The system operates by downloading a terminal services control to the web browser. Next, the user receives a logon window from the server. After logging on to the server through the logon window, the user accesses the virtual desktop on the server through the web browser.

In one embodiment of the present invention, the user selects the server using the terminal services control.

In one embodiment of the present invention, the server is a virtual server that is one of a plurality of virtual servers hosted on a common server platform.

In one embodiment of the present invention, the system provides security for the virtual server from unauthorized access by a second virtual server.

In one embodiment of the present invention, the system chooses a snap-in to provide a capability to the user from the virtual desktop. The snap-in controls the capability of the user.

In one embodiment of the present invention, the capability includes, but is not limited to, file management, folder management, database access using structured query language, electronic mail, and an Internet information server based system-level manipulation utility.

In one embodiment of the present invention, the capability includes technical support and system administration available to a provider of the server.

In one embodiment of the present invention, the system uses a wireless application protocol device to access the virtual desktop.

### BRIEF DESCRIPTION OF THE FIGURES

FIG. 1 illustrates computing devices coupled together in accordance with an embodiment of the present invention.

FIG. 2 illustrates access to snap-ins using web browser 202 in accordance with an embodiment of the present invention.

FIG. 3 is a flowchart illustrating the process of accessing functionality using web browser 202 in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computing Devices

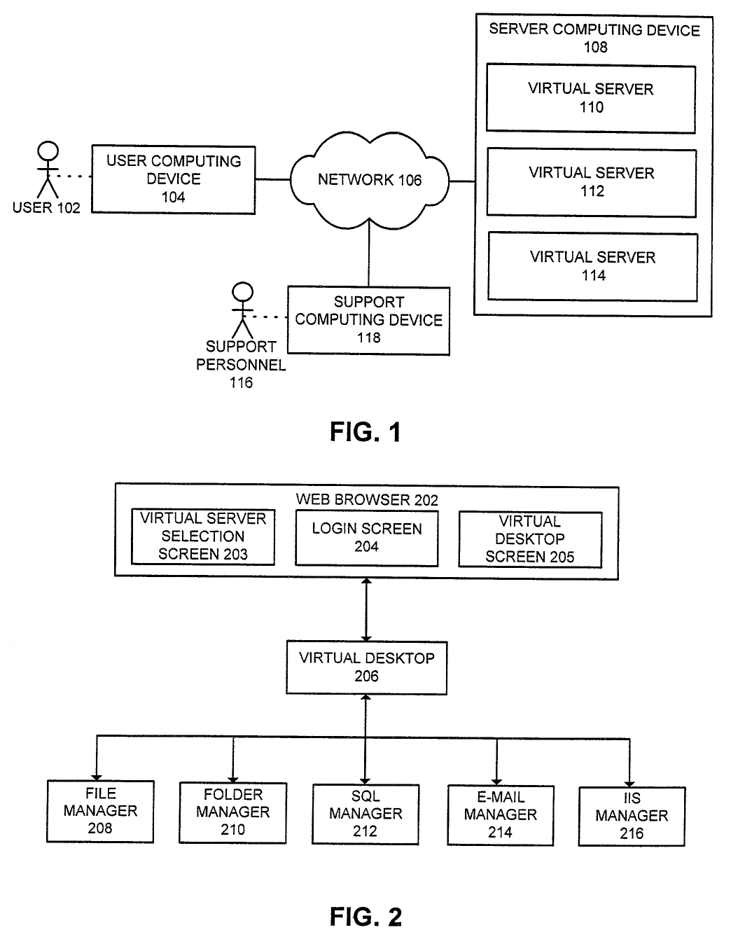

FIG. 1 illustrates computing devices coupled together in accordance with an embodiment of the present invention. The system includes user computing device 104, support computing device 118, server computing device 108, network 106, user 102, and support personnel 116.

These computing devices can generally include any type of computer system, including, but not limited to, a computer system based on a microprocessor, a mainframe computer, a digital signal processor, a portable computing device, a personal organizer, a device controller, and a computational engine within an appliance.

Network 106 can generally include any type of wire or wireless communication channel capable of coupling together computing nodes. This includes, but is not limited to, a local area network, a wide area network, or a combination of networks. In one embodiment of the present invention, network 106 includes the Internet.

Server computing device 108 includes virtual servers 110, 112, and 114. Virtual servers 110, 112, and 114 supply computer operating system services to a user so that the user has the equivalent support of a stand-alone computing device. Note that server computing device can host more or less than the number of virtual servers shown in FIG. 1.

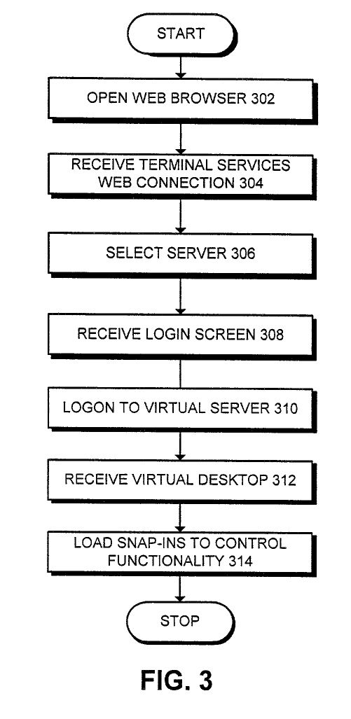

User 102 interacts with a virtual server, say virtual server 112, within server computing device 108 through user computing device 104. User 102 can include an administrator who supplies snap-ins as described in conjunction with FIG. 3 and, in general, specifies user privileges for virtual server 112.

Support personnel 116 provide support services for server computing device 108 using support computing device 118. These services include establishing virtual servers, creating accounts for users, maintaining the virtual servers, and assisting users in solving problems.

System Functionality

FIG. 2 illustrates the process of accessing snap-ins using web browser 202 in accordance with an embodiment of the present invention. User 102 accesses server computing device 108 across network 106 using web browser 202. Web browser 202 presents virtual server selection screen 203 to user 102. Microsoft Windows 2000 Terminal Services Web Connection can provide virtual server selection screen 203.

Microsoft, Windows 2000, Microsoft Exchange, and Microsoft Management Console are trademarks or registered trademarks of Microsoft Corporation, Redmond, Wash., in the United States and in other countries.

User 102 uses virtual server selection screen 203 to select a virtual server, say virtual server 112. Next, web browser 202 presents login screen 204 to user 102 so that user 102 can log in to virtual server 112. After successfully logging in to virtual server 112, web browser 202 displays virtual desktop 206 using virtual desktop screen 205.

Virtual desktop 206 provides user 102 with a familiar Windows screen including shortcuts for the programs and operations available to user 102. Virtual desktop 206 can include advertising icons, which can be a revenue source for the provider of server computing device 108.

Virtual desktop 206 uses the Microsoft Management Console (MMC) to control the extent of capabilities extended to user 102. The MMC provides a framework for various snap-ins, which allow user 102 to access file manager 208, folder manager 210, structured query language (SQL) manager 212, e-mail manager 214, and Internet information server (IIS) 216. Note that the snap-ins are not limited to the ones listed. A practitioner with ordinary skill in the art will be able to add a snap-in to control any desired functionality.

File manager 208 allows user 102 to access files stored on virtual server 112. File manager 208 includes functionality to create, copy, delete, and move files.

Folder manager 210 allows user 102 to arrange files stored on virtual server 112. Folder manager includes functionality to create, copy, delete, and move folders.

SQL manager 212 allows user 102 to access database files. SQL manager 212 includes functionality to view the contents of a database file according to an entered search criteria.

E-mail manager 214 allows user 102 to process electronic mail messages E-mail manager 214 includes functionality to create, send, receive, sort, delete, and forward electronic mail messages.

IIS manager 216 allows user 102 in the role of an administrator access to administration functions on virtual server 112. IIS manager 216 includes functionality for remote administration of Microsoft Exchange, IIS and active directory management within a controlled and secure environment.

Accessing Functionality

FIG. 3 is a flowchart illustrating the process of accessing functionality using web browser 202 in accordance with an embodiment of the present invention. The system starts when user 102 opens web browser 202 on user computing device 104 (step 302). Next, user 102 receives a terminal services web connection from server computing device 108 (step 304). The terminal services web connection includes virtual server selection screen 203. User 102 then selects the desired virtual server, say virtual server 112 (step 306).

After selecting the virtual server, user 102 receives login screen 204 from virtual server 112 (step 308). Next, user 102 uses login screen 204 to log in to virtual server 112 (step 310).

User 102 then receives virtual desktop 206 (step 312). Virtual desktop 206 uses Microsoft Management Console (MMC) to allow control of functionality. The MMC loads snap-ins to control functionality for user 102 (step 314). Note that support personnel 116 use support computing device 118 to access functionality in the same manner that user 102 uses user computing device 104. Support personnel 116 have less restrictions than user 102, and can access control mechanism of server computing device 108 as well as the control mechanisms for the individual virtual servers.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method to facilitate remote access by a user to a virtual desktop on a server through a web browser, comprising:
downloading a terminal services control to the web browser;
receiving a logon window from the server;
logging on to the server through the logon window; and
accessing the virtual desktop on the server through the web browser.

2. The method of claim 1, further comprising selecting the server using the terminal services control.

3. The method of claim 1, wherein the server is a virtual server of a plurality of virtual servers hosted on a common server platform.

4. The method of claim 3, further comprising providing security for the virtual server from unauthorized access by a second virtual server of the plurality of virtual servers.

5. The method of claim 1, further comprising:
choosing a snap-in to provide a capability to the user from the virtual desktop; and
controlling the capability of the user with the snap-in.

6. The method of claim 5, wherein the capability includes, but is not limited to, one of, file management, folder management, database access using structured query language, electronic mail, and an Internet information server based system-level manipulation utility.

7. The method of claim 5, wherein the capability includes technical support and system administration available to a provider of the server.

8. The method of claim 1, further comprising using a wireless application protocol device to access the virtual desktop.

9. A computer-readable storage medium storing instructions that when executed by a computer cause the computer to perform a method to facilitate remote access by a user to a virtual desktop on a server through a web browser, the method comprising:
downloading a terminal services control to the web browser;
receiving a logon window from the server;
logging on to the server through the logon window; and
accessing the virtual desktop on the server through the web browser.

10. The computer-readable storage medium of claim 9, the method further comprising selecting the server using the terminal services control.

11. The computer-readable storage medium of claim 9, wherein the server is a virtual server of a plurality of virtual servers hosted on a common server platform.

12. The computer-readable storage medium of claim 11, the method further comprising providing security for the virtual server from unauthorized access by a second virtual server of the plurality of virtual servers.

13. The computer-readable storage medium of claim 9, the method further comprising:
choosing a snap-in to provide a capability to the user from the virtual desktop; and
controlling the capability of the user with the snap-in.

14. The computer-readable storage medium of claim 13, wherein the capability includes, but is not limited to, one of, file management, folder management, database access using structured query language, electronic mail, and an Internet information server based system-level manipulation utility.

15. The computer-readable storage medium of claim 13, wherein the capability includes technical support and system administration available to a provider of the server.

16. The computer-readable storage medium of claim 9, the method further comprising using a wireless application protocol device to access the virtual desktop.

17. An apparatus that facilitates remote access by a user to a virtual desktop on a server through a web browser, comprising:
a downloading mechanism that is configured to download a terminal services control to the web browser;
a receiving mechanism that is configured to receive a logon window from the server;
a log on mechanism that is configured to log on to the server through the logon window; and
an accessing mechanism that is configured to access the virtual desktop on the server through the web browser.

18. The apparatus of claim 17, further comprising a selecting mechanism that is configured to allow the user to select the server using the terminal services control.

19. The apparatus of claim 17, wherein the server is a virtual server of a plurality of virtual servers hosted on a common server platform.

20. The apparatus of claim 19, further comprising a providing mechanism that is configured to provide security for the virtual server from unauthorized access by a second virtual server of the plurality of virtual servers.

21. The apparatus of claim 17, further comprising:
a choosing mechanism that is configured to choose a snap-in to provide a capability to the user from the virtual desktop; and
a controlling mechanism that is configured to control the capability of the user with the snap-in.

22. The apparatus of claim 21, wherein the capability includes, but is not limited to, one of, file management, folder management, database access using structured query language, electronic mail, and an Internet information server based system-level manipulation utility.

23. The apparatus of claim 21, wherein the capability includes technical support and system administration available to a provider of the server.

24. The apparatus of claim 17, further comprising a using mechanism that is configured to use a wireless application protocol device to access the virtual desktop.
